(19) United States
(12) Patent Application Publication
(10) Pub. No.: US 2002/0138258 A1
(43) Pub. Date: Sep. 26, 2002

(54) Noise reduction system, and method

(76) Inventors: Ulf Knoblich, Birkenfeld (DE); Jurgen Sienel, Leonberg (DE); Dieter Kopp, Illingen (DE)

Correspondence Address: Sughrue Mion, 2100 Pennsylvania Avenue N W, Washington, DC, 20037-3213, US

(21) Appl. No.: 10/069,443

(22) PCT Filed: May 7, 2001
(86) PCT No.: PCT/EP01/05132

(30) Foreign Application Priority Data
Jul. 5, 2000 (EP) 00440205.3

(51) Int. Cl. G10L 21/00

(52) U.S. Cl. 704/226

(57) ABSTRACT

Noise reduction systems comprising an input for receiving per time-interval input signals originating from a Fast Fourier Transformator (frequency-components+values/amplitudes) and comprising a noise estimator coupled to said input for performing noise estimations per input signal and comprising a converter coupled to said noise estimator for performing conversions of said noise estimations and for generating correction signals and comprising a combiner coupled to said converter and to said input for generating per time-interval output signals (input signals minus correction signals=frequency-components +values/amplitudes with reduced noise) do not take into account their surroundings and are rather static. By introducing adaptation signals for adapting said conversions, noise reduction systems become dynamic and more flexible.

The invention relates to a noise reduction system comprising an input for receiving per time-interval at least two input signals and comprising a noise estimator coupled to said input for performing noise estimations per input signal and comprising a converter coupled to said noise estimator for performing conversions of said noise estimations and for generating correction signals and comprising a combiner coupled to said converter and to said input for generating at least two output signals per time-interval.

Such a noise reduction system is of common general knowledge, with said time-interval for example being (a part of) a frame of for example 10 msec. or 20 msec. and with said input signals for example being 30 (or 40 or 128 or 256 etc.) values/amplitudes of 30 (or 40 or 128 or 256 etc.) frequency-components. Said input signals for example originate from a Fast Fourier Transformator (FFT), which in response to speech entered at a man-machine-interface for example generates per time-interval 256 frequency-components+values/amplitudes, which possible via for example a MEL-filter are reduced to 30 or 40 frequency-components+values/amplitudes which then are supplied to said input of said noise reduction system. Said noise estimator is of common general knowledge and performs a noise estimation per input signal (frequency-component) per time-interval, for example by storing, before said speech is entered, per input signal a value/amplitude of said input signal, and by, during a next time-interval, comparing a new value/amplitude with said stored old value/amplitude, and in dependence of a comparison result generating a noise estimation signal. Said converter is of common general knowledge and for example based upon the article “Frequency domain noise suppression approaches in mobile telephone systems”, by Jin Yang, ICASSP-1993, Volume II, 0-7803-0946-4/93, 1993 IEEE, four pages. Said combiner for example subtracts, per time-interval and per input signal, said correction signals from said input signals, resulting in said generated output signals which correspond with said input signals, now however with reduced noise and thus a higher signal-to-noise-ratio (SNR).

Such a noise reduction system is disadvantageous, inter alia, due to being static and insufficiently flexible.

It is an object of the invention, inter alia, to provide a noise reduction system as described in the preamble, which is dynamic and more flexible.

Thereto, the noise reduction system according to the invention is characterised in that said converter comprises a control input for receiving adaptation signals for adapting said conversions.

By making said conversions adaptable, the noise reduction system has become dynamic and more flexible.

The invention is based on the insight, inter alia, that different surroundings require different noise reduction systems.

The invention solves the problem, inter alia, of providing a noise reduction system which is dynamic and more flexible.

A first embodiment of the noise reduction system according to the invention is characterised in that said noise reduction system comprises a generator coupled to said noise estimator for generating said adaptation signals in dependence of said noise estimations.

By introducing said generator for, per input signal, in response to noise estimation signals generating said adaptation signals, a noise-based adaptivity has been created. Said generator may generate said adaptation signals each time-interval or just during certain time-intervals (situated at the beginning).

A second embodiment of the noise reduction system according to the invention is characterised in that said generator generates said adaptation signals by scaling said noise estimations, with said scaling being dependent upon said noise estimations.

By introducing said generator for, per input signal, scaling said noise estimation signals, with each noise estimation signal being scaled in dependence of at least further noise estimation signals arrived in the same time-interval, said noise-based adaptivity takes into account a further part of the frequency spectrum for this time-interval.

A third embodiment of the noise reduction system according to the invention is characterised in that said noise estimation per input signal starts with averaging each input signal received during several time-intervals.

By starting with averaging each input signal received during several time-intervals, preferably before said speech is entered, said noise estimator has a better accuracy.

A fourth embodiment of the noise reduction system according to the invention is characterised in that said noise reduction system comprises a smoother for receiving said correction signals and smoothing them and supplying them to said combiner.

By introducing said smoother for smoothing said correction signals, with each correction signal being smoothed in dependence of at least further correction signals arrived in the same time-interval, said correction takes into account a further part of the frequency spectrum for this time-interval.

A fifth embodiment of the noise reduction system according to the invention is characterised in that said converter performs said conversions at the hand of tables, with said adaptation signals adapting said tables.

By using tables, there is no need for making calculations each time-interval. Said adaptation can be done once at the beginning or as many times as needed.

A sixth embodiment of the noise reduction system according to the invention is characterised in that said converter performs said conversions at the hand of functions, with said adaptation signals adapting said functions.

By using functions, there is a need for making calculations each time-interval, which however provides a higher flexibility. Said adaptation can be done once at the beginning or as many times as needed.

The invention further relates to a method for reducing noise per time-interval for at least two input signals and comprising a first step of performing noise estimations per input signal and a second step of performing conversions of said noise estimations and a third step of generating correction signals and a fourth step of generating at least two output signals per time-interval, characterised in that said method comprises a fifth step of receiving adaptation signals for adapting said conversions.

The method according to the invention is characterised in that said method comprises a fifth step of receiving adaptation signals for adapting said conversions.

A first embodiment of the method according to the invention is characterised in that said method comprises a sixth step of generating said adaptation signals in dependence of said noise estimations.

A second embodiment of the method according to the invention is characterised in that said sixth step comprises a substep of generating said adaptation signals by scaling said noise estimations, with said scaling being dependent upon said noise estimations.

Further embodiments of the method according to the invention are in line with the embodiments of the noise reduction system according to the invention.

Said noise reduction system according to the invention could for example be used in a Distributed Speech Recognition environment (DSR), like a terminal and/or a network. The document U.S. Pat. No. 5,809,464 discloses a dictating mechanism based upon distributed speech recognition (DSR). Other documents being related to DSR are for example EP00440016.4 and EP00440057.8. The document EP00440087.5 discloses a system for performing vocal commanding. The document U.S. Pat. No. 5,794,195 discloses a start/end point detection for word recognition. The document U.S. Pat. No. 5,732,141 discloses a voice activity detection. Neither one of these documents discloses the noise reduction system according to the invention. All references including further references cited with respect to and/or inside said references (and/or including the article “Frequency domain noise suppression approaches in mobile telephone systems”, by Jin Yang, ICASSP-1993, Volume II, 0-7803-0946-4/93, 1993 IEEE, four pages) are considered to be incorporated in this patent application.

The invention will be further explained at the hand of an embodiment described with respect to drawings, whereby

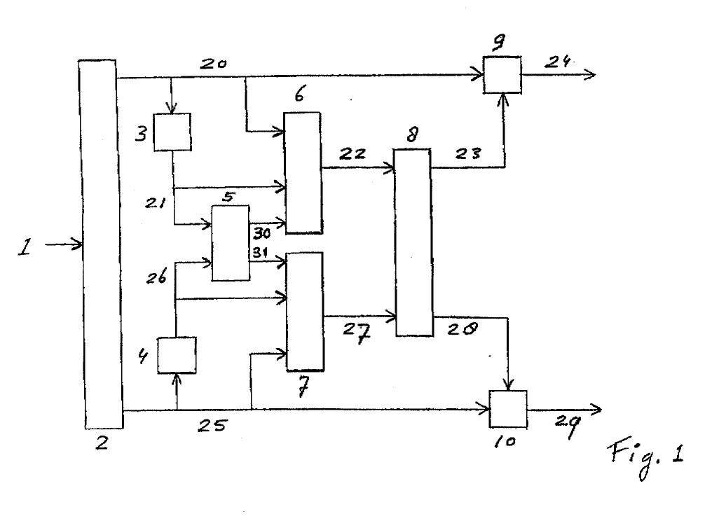

FIG. 1 discloses a noise reduction system according to the invention comprising a noise estimator, a converter, a combiner and a generator.

The noise reduction system according to the invention as shown in FIG. 1 comprises an input 1 coupled to a filter bank 2, of which a first output via a connection 20 is coupled to an input of noise estimator 3 and to a first input of converter 6 and to a first of combiner 9, and of which a second output via a connection 25 is coupled to an input of noise estimator 4 and to a first input of converter 7 and to a first input of combiner 10. An output of noise estimator 3 is coupled via a connection 21 to a second input of converter 6 and to a first input of generator 5. An output of noise estimator 4 is coupled via a connection 26 to a second input of converter 7 and to a second input of generator 5. A first output of generator 5 is coupled via a connection 30 to a third input of converter 6, and a second output of generator 5 is coupled via a connection 31 to a third input of converter 7. An output of converter 6 is coupled via a connection 22 to a first input of smoother 8, and an output of converter 7 is coupled via a connection 27 to a second input of smoother 8, of which a first output is coupled via a connection 23 to a second input of combiner 9 and of which a second output is coupled via a connection 28 to a second input of combiner 10. An output of combiner 9 is coupled to connection 24 and an output of combiner 10 is coupled to a connection 29.

The noise reduction system according to the invention as shown in FIG. 1 comprises two noise estimators and two converters and two combiners for dealing with two input signals per time-interval (two frequency-components+values/amplitudes). In case of 30 (40, 128, 256 etc.) input signals per time-interval, there will be 30 (40, 128, 256 etc.) noise estimators, 30 (40, 128, 256 etc.) converters, 30 (40, 128, 256 etc.) combiners, and generator 5 and smoother 8 will each have 30 (40, 128, 256 etc.) inputs and 30 (40, 128, 256 etc.) outputs.

The noise reduction system according to the invention as shown in FIG. 1 functions as follows.

Via input 1, for example from a Fast Fourier Transformator (FFT) not shown, and possibly via for example a MEL-filter, several input signals per time-interval (of for example 10 msec. or 20 msec.) arrive, with each input signal being a frequency-component having a certain value/amplitude.

A first input signal (first frequency-component+first value/amplitude) is supplied via connection 20 to noise estimator 3, which for example has calculated the first average of several first input signals received during several time-intervals, preferably before a user started entering speech at a man-machine-interface not shown and coupled to said FFT not shown, and which calculates, for next time-intervals, a difference between a present first input signal and said first average, and then possibly calculates and stores a new first average, and generates a first noise estimation signal which via connection 21 is supplied to said second input of converter 6. Said present first input signal is supplied to said first input of converter 6, which for example is in the form of a first table or a calculator for calculating a first function. In response to both said present first input signal and said first noise estimation signal, converter 6 performs a first conversion (consults said first table or performs said calculation of said first function) and generates a first correction signal (first correction value/amplitude), which via connection 22 is supplied to a first input of smoother 8.

A second input signal (second frequency-component+second value/amplitude) is supplied via connection 25 to noise estimator 4, which for example has calculated the second average of several second input signals received during several time-intervals, preferably before a user started entering speech at a man-machine-interface not shown and coupled to said FFT not shown, and which calculates, for next time-intervals, a difference between a present second input signal and said second average, and then possibly calculates and stores a new second average, and generates a second noise estimation signal which via connection 26 is supplied to said second input of converter 7. Said present second input signal is supplied to said first input of converter 7, which for example is in the form of a second table or a calculator for calculating a second function. In response to both said present second input signal and said second noise estimation signal, converter 7 performs a second conversion (consults said second table or performs said calculation of said second function) and generates a second correction signal (second correction value/amplitude), which via connection 27 is supplied to a second input of smoother 8.

Smoother 8 which itself is of common general knowledge to a person skilled in the art, smoothes both said first correction signal and said second correction signal (by for example calculating the sum and dividing each correction signal by this sum, and/or by processing each correction signal individually), and supplies a smoothed first correction signal via connection 23 to combiner 9 and supplies a smoothed second correction signal via connection 28 to combiner 10. As a result, combiner 9 subtracts said smoothed first correction signal-from said first input signal and generates a first output signal being a corrected first input signal now comprising less noise and having a better signal-to-noise-ratio (SNR) than said original first input signal, and combiner 10 subtracts said smoothed second correction signal from said second input signal and generates a second output signal being a corrected second input signal now comprising less noise and having a better signal-to-noise-ratio (SNR) than said original second input signal.

Due to noise estimators 3 and 4 calculating the averages of several input signals received during several (for example ten) time-intervals, preferably before a user started entering speech, and calculating, for next time-intervals, differences between present input signals and said averages, and then possibly calculating and storing new averages, the accuracy of the generated noise estimation signals is improved a lot.

Said functioning of said noise reduction system as described above, however, is rather static and insufficiently flexible. To make said noise reduction system more dynamic and flexible, for example said generator 5 has been introduced.

According to a first possibility, generator 5 just receives the first noise estimation signal(s) and the second noise estimation signal(s) for the first or said several (for example ten) time-intervals, and calculates a first adaptation signal which is supplied to said third input of converter 6 via a connection 30 and calculates a second adaptation signal which is supplied to said third input of converter 7 via a connection 31. In response to said adaptation signals, said converters 6 and 7 adapt their conversions (by for example shifting their table horizontally and/or vertically or by adapting their function via for example amending parameters). As a result, said correction signals are more dynamic and surroundings-conditions are taken into account, and said noise reduction system is more flexible (no longer need said converters to be designed per application, but universal converters can be applied, which then are adapted by said adaptation signals in dependence of surroundings-conditions).

According to a second possibility, generator 5 receives each first noise estimation signal and each second noise estimation signal for each time-interval, and calculates a first adaptation signal by for example scaling all noise estimation signals received for a particular time-interval (like taking a sum, and dividing said first noise estimation signal by said sum) and/or processing said first noise estimation signal individually, and calculates a second adaptation signal by for example scaling all noise estimation signals received for a particular time-interval (like taking a sum, and dividing said second noise estimation signal by said sum) and/or processing said second noise estimation signal individually. Again in response to said adaptation signals, said converters 6 and 7 adapt their conversions (by for example shifting their table horizontally and/or vertically or by adapting their function via for example amending parameters), etc.

Instead of said first and second input of converters 6 and 7, each converter may have one common input, whereby each noise estimator for example generates a ratio of said noise estimation signal and said input signal.

For sake of clarity, timing signals have not been shown in FIG. 1, and for example said noise estimator, and/or said converters and/or said combiners may be provided with memories and/or buffers for solving problems due to signals not arriving at (nearly) the same moment.

Of course, instead of all noise estimators, one or more processors could perform their function, and instead of all converters, one or more processors could perform their function, and instead of all combiners, one or more processors could perform their function, and functions of said generator and said smoother could be performed by one or more processors. So, in fact, the entire noise reduction system shown in FIG. 1 could be realised by one or more processors.

All embodiments are just embodiments and do not exclude other embodiments not shown and/or described. All examples are just examples and do not exclude other examples not shown and/or described. Any (part of an) embodiment and/or any (part of an) example can be combined with any other (part of an) embodiment and/or any other (part of an) example.

Said construction can be amended without departing from the scope of this invention. Said units and/or blocks, as well as all other units and/or blocks shown and/or not shown, can be 100% hardware, or 100% software, or a mixture of both. Each unit and/or block can be integrated with a processor or any other unit and/or block, and each function of a processor can be realised by a separate unit and/or block.

Said combiners are shown as subtractors, but could further be realised for example in the form of adders (in case said converters for example supply correction signals having a negative value) or for example in the form of multiplicators (in case said converters for example supply correction signals in the form of a ratio) etc.

Said smoother, in case of for example 30 or 40 or more correction signals arriving per time-interval, for example for at least one specific correction signal take two further (for example neighbouring) correction signals situated left from said specific correction signal in the frequency spectrum and take two further (for example neighbouring) correction signals situated right from said specific correction signal in the frequency spectrum and multiply the one most left with 0.1 and multiply the next one with 0.2 and multiply the specific one with 0.4 or 0.5 or 0.6 and multiply the next one with 0.2 and multiply the one most right with 0.1 and take the sum as the smoothed correction signal for said specific correction signal, etc.

1. Noise reduction system comprising an input for receiving per time-interval at least two input signals and comprising a noise estimator coupled to said input for performing noise estimations per input signal and comprising a converter coupled to said noise estimator for performing conversions of said noise estimations and for generating correction signals and comprising a combiner coupled to said converter and to said input for generating at least two output signals per time-interval, characterised in that said converter comprises a control input for receiving adaptation signals for adapting said conversions.

2. Noise reduction system according to claim 1, characterised in that said noise reduction system comprises a generator coupled to said noise estimator for generating said adaptation signals in dependence of said noise estimations.

3. Noise reduction system according to claim 2, characterised in that said generator generates said adaptation signals by scaling said noise estimations, with said scaling being dependent upon said noise estimations.

4. Noise reduction system according to claim 1, 2 or 3, characterised in that sad noise estimation per input signal starts with averaging each input signal received during several time-intervals.

5. Noise reduction system according to claim 1, 2, 3 or 4, characterised in that said noise reduction system comprises a smoother for receiving said correction signals and smoothing them and supplying them to said combiner.

6. Noise reduction system according to claim 1, 2, 3, 4 or 5, characterised in that said converter performs said conversions at the hand of tables, with said adaptation signals adapting said tables.

7. Noise reduction system according to claim 1, 2, 3, 4 or 5, characterised in that said converter performs said conversions at the hand of functions, with said adaptation signals adapting said functions.

8. Method for reducing noise per time-interval for at least two input signals and comprising a first step of performing noise estimations per input signal and a second step of performing conversions of said noise estimations and a third step of generating correction signals and a fourth step of generating at least two output signals per time-interval, characterised in that said method comprises a fifth step of receiving adaptation signals for adapting said conversions.

9. Method according to claim 8, characterised in that said method comprises a sixth step of generating said adaptation signals in dependence of said noise estimations.

10. Method according to claim 9, characterised in that said sixth step comprises a substep of generating said adaptation signals by scaling said noise estimations, with said scaling being dependent upon said noise estimations.
